(19) United States
(12) Patent Application Publication
(10) Pub. No.: US 2026/0078504 A1
(43) Pub. Date: Mar. 19, 2026

(54) ELECTROLYSIS CELL

(71) Applicant: thyssenkrupp nucera AG & Co. KGaA, Dortmund (DE)

(72) Inventors: Peter TOROS, Essen (DE); Sebastian AUSTENFELD, Soest (DE)

(73) Assignee: thyssenkrupp nucera AG & Co. KGaA, Dortmund (DE)

(21) Appl. No.: 19/109,893

(22) PCT Filed: Sep. 5, 2023
(86) PCT No.: PCT/EP2023/074299

§ 371 Date: Mar. 7, 2025

(30) Foreign Application Priority Data
Sep. 15, 2022 (EP) 22195950.5

(51) Int. Cl. C25B 9/65; C25B 1/04; C25B 1/34

(52) U.S. Cl. CPC C25B 9/65; C25B 1/04; C25B 1/34

(57) ABSTRACT

An electrolysis cell for chlor-alkali or alkaline water electrolysis comprises two cell elements each defining an electrode chamber by providing a back wall and sidewalls of the electrode chambers, and a sheet-like separator being interposed in a joint between the two cell elements and providing a separating wall between the electrode chambers, wherein an electrode and an electrode support unit is accommodated in each of the electrode chambers, wherein the electrode support units provide an electrical connection between the back wall and the electrode in each of the electrode chambers, wherein the electrodes are in direct contact with the sheet-like separator, and wherein at least in one of the electrode chambers the electrical connection between the back wall and the electrode support unit and/or between the electrode support unit and the electrode is provided by means of a surface contact connection.

### BACKGROUND OF THE INVENTION

The invention relates to an electrolysis cell according to the preamble of claim 1.

Electrolysis cells for large-scale production of hydrogen by alkaline water electrolysis or chlorine by chlor-alkali electrolysis are typically stacked in an electrolyzer being electrically connected in series. The outmost cells of the cell stack of the electrolyzer are connected to a power source, while the electrodes of adjacent cells within the stack are electrically connected to each other, forming bipolar electrodes within the electric field of the power source.

From EP 0 500 505 A1 an electrolyzer of the so-called filter press configuration having such bipolar elements is known. In this filter press configuration, frames providing back walls of the cells, half-electrodes, intermediate frames and separators are stacked, wherein the electrodes extend at one side to the outside of the frames. Neighboring electrodes are connected to each other outside of the cells e.g. by bolting. This has the advantage that the electrolyzer can be manufactured without weldings. However, the known configuration has the disadvantage of an uneven current distribution across the electrodes as the electrically current enters and exits the electrode sheets only on one side. At high current densities, this leads to a comparatively low degree of efficiency of the cell and a rapid degeneration of the separators in the most loaded regions of the electrodes.

Therefore, it has become a favored design to directly connect the electrodes of adjacent cells in the stack at several positions distributed over the electrode area via the associated back wall of the cell. Such a configuration is for example known from EP 3 778 991 A1 that describes an electrolysis vessel for alkaline water electrolysis. The anodes and the cathodes are fixed and held by electroconductive ribs within the anode chamber and the cathode chamber, respectively, wherein the electroconductive ribs protrude from the separating back walls of the respective chamber. US 2011/0259735 A1 describes a generally similar design, with a zero-gap configuration, however, in which an elastic conductive element is interposed between the current distributor fixed to the back wall and a flexible planar cathode that is kept in contact with the separator. In generalized terms, the typical cell design thus comprises two cell elements each defining an electrode chamber, in which an electrode and an electrode support unit is accommodated. The electrode support unit provides an electrical connection between the back wall and the electrode.

In order to fix the electrodes within the cell and to secure the electrical contact between the back wall and the associated electrode permanently within the corrosive environment within the cell, the electrode is welded to the electrode support unit, which itself is welded to the back wall of the cell. Thus, the current path from the back wall to the electrode can be guaranteed for years of operating time by the firm material bond between the components of the cell. However, welded connections have the disadvantage that they are labor intensive to produce and result in high manufacturing costs. Moreover, after some years of service, electrolysis cells need to be refurbished, wherein the coating of the electrodes has to be renewed. Thus, for refurbishment the electrodes have to be separated from the support units again, which is difficult for welded connections and involves the risk of damaging the welded components. Moreover, welding requires a minimum sheet thickness of the welding partners in order to ensure leak-tightness of the weld.

### BRIEF SUMMARY OF INVENTION

The object of the invention is therefore to provide an electrolysis cell for chlor-alkali or alkaline water electrolysis that is suitable for use at high current densities and is easy to manufacture and refurbish at the same time.

This object is achieved by an electrolysis cell according to the features of claim 1.

Hereby, an electrolysis cell for chlor-alkali or alkaline water electrolysis is provided. The electrolysis cell comprises two cell elements. Each of the cell elements defines an electrode chamber by providing a back wall and sidewalls of the electrode chambers. The electrolysis cell further comprises a sheet-like separator that is interposed in a joint between the two cell elements and provides a separating wall between the electrode chambers. In each of the electrode chambers an electrode and an electrode support unit is accommodated, wherein the electrode support units provide an electrical connection between the back wall and the electrode in each of the electrode chambers, and wherein the electrodes are in direct contact with the sheet-like separator. According to the invention at least in one of the electrode chambers, the electrical connection between the back wall and the electrode support unit and/or between the electrode support unit and the electrode is provided by means of a surface contact connection.

The surface contact connection according to the invention establishes the electrical connection by a surface contact pressure between the connected cell components, i.e. back wall and the electrode support unit and/or the electrode. Thus, any material bond between the connected components is dispensed with. The connected components can be taken apart upon release of the surface pressure. Advantageously, the force exerted on the cell elements to close the cell in the joint of the cell elements during assembly is used simultaneously to establish the surface contact pressure between the connected cell components, and thus to fix the electrode at its mounting position within the cell.

In particular, it is preferred, if the electrode support unit is connected to both, the back wall and the electrode by a surface contact connection. Then, the inventive cell contains at least one half shell that comprises three independent units that are not joined by welding: The cell element, forming the housing of the cell and including all required means for feeding and discharging of operational fluids, the electrode as the electrochemically active unit and the electrode support unit that provides mechanical support for the cell element and the electrode, transfers electric current from the back wall to the electrode and provides sufficient space for equalized supply of operational fluids to the electrode.

Surface contact connections that are easily detachable have high practical benefits not only for cell assembly. Upon opening the cell, e.g. for refurbishment, the connected components become loose again and can be removed individually from the cell. Refurbishment of the cells can be carried out on site by simply replacing the worn parts saving significant costs for downtimes. Further, by making use of non-welded surface contact connections, thinner sheet metal material can be used without the risk of leakages, resulting in a more sustainable cell design.

In preferred embodiments, the electrode chamber, in which the surface contact connection is provided, is an anode chamber of the electrolysis cell comprising an anode as electrode. Of the two electrode chambers, the cathode chamber and the anode chamber, the harsher conditions prevail in the anode chamber due to the oxidizing effect of the electrolysis product produced here, i.e. chlorine or oxygen. Hence, anode chambers and the anodes themselves have particularly high refurbishment requirements and need often be replaced.

In preferred embodiments, the surface contact connection comprises a contact surface that is equipped at least in part with a contact improving coating. In order to prevent corrosion and/or passivation on the contact surfaces and to reduce the contact resistance of the surface contact connection in the corrosive environment of the cell, a contact improving coating may be provided on the contact surfaces of the connection. Preferably, a contact improving coating is used at least in the anode chamber of the electrolysis cell. Preferably, the contact improving coating contains one or more of the materials gold, silver, platinum, ruthenium, palladium and NiV7. In particular, it is preferred if contact improving coatings are provided on both mutually touching contact surfaces of the surface contact connection.

In further preferred embodiments, the contact improving coating is provided on an intermediary coating carrier layer that is attached in a material bond to the back wall, the electrode support unit and/or the electrode, respectively. An intermediary coating carrier layer is preferred depending on the material combination of coating and base material. For example, an intermediary coating carrier layer made of nickel may be used to apply a coating to an electrode, an electrode support unit or a back wall made from titanium. Another practical reason for a coating carrier layer is to simplify the surface geometry to be coated. While it might be difficult to apply a coating to e.g. an expanded mesh, it is easier and more efficient to apply the coating to a piece of metal with a flat surface structure, e.g. a stripe, a disc or a coin serving as an intermediary coating carrier layer, and to fix that intermediary coating carrier layer to the expanded mesh, e.g. by welding.

In some embodiments, the surface contact connection can be secured by a mechanical joint. The mechanical joint is preferably a separable mechanical joint, in particular a hooked or clamped connection. A mechanical joint in addition to the surface contact connection has the advantage of holding the electrode and/or the electrode support unit in place during assembly of the cell in a pre-assembled state, before a surface contact pressure is applied to the surface contact connection. The main purpose of the mechanical joint is thus to simplify handling of the cell during assembly and mounting within the electrolyzer.

Preferably, the electrode support unit comprises a truss made of sheet metal strips. A truss of metal strips has the advantage of providing a lightweight support structure that forms a dimensionally stable unit on its own and is capable of carrying high surface pressing forces. Sheet metal strips are further easy to be processed during manufacture.

In other preferred embodiments, the electrode support unit comprises an electrically conductive distance fabric. The distance fabric preferably has pole threads with an inherent rigidity that are compressed during assembly of the cell and provide for the contact surface pressure of the surface contact connection. In addition, at least part of the pole threads are made from or are coated with an electrically conductive material. In general, also other lightweight structures as e.g. honeycomb or metal foam structures are imaginable to be used as electrode support units.

In still other embodiments, the electrode support unit comprises arc springs that are convexly arched towards the electrode to provide a resilient support surface for the electrode. During assembly of the cell, the arc springs are compressed and provide for the contact surface pressure of the surface contact connection.

Preferably, the back wall, the electrode support unit, and or the electrode are made from nickel or titanium, which combine a high degree of efficiency with high endurance within the chemical environment of the cell.

Further advantages of the invention are described in the following with regard to the embodiments shown in the attached drawings.

### BRIEF DESCRIPTION OF DRAWINGS

FIG. 1A shows schematically a cross-sectional view of an electrolysis cell according to the invention in an exploded view,

FIG. 1B shows schematically the electrolysis cell of FIG. 1 in an assembled state,

FIGS. 2A and 2B show schematically detailed views of the surface contact connection according to FIGS. 1A and 1B having a contact improving coating, without and with an intermediary coating carrier layer, respectively,

FIG. 3 shows schematically a detailed perspective view of the electrode support unit of the embodiment according to FIGS. 1A and 1B that comprises a truss made of sheet metal strips,

FIG. 4 shows schematically a second embodiment of the electrolysis cell according to the invention, wherein the electrode support unit is connected to both, the back wall and the electrode by a surface contact connection,

FIG. 5 shows schematically a third embodiment of the electrolysis cell according to the invention, wherein the electrode support unit comprises an electrically conductive distance fabric,

FIG. 6 shows schematically a fourth embodiment of the electrolysis cell according to the invention, wherein the electrode support unit comprises arc springs that are convexly arched towards the electrode.

### DETAILED DESCRIPTION OF INVENTION

In the drawings same parts are consistently identified by the same reference signs and are therefore generally described and referred to only once.

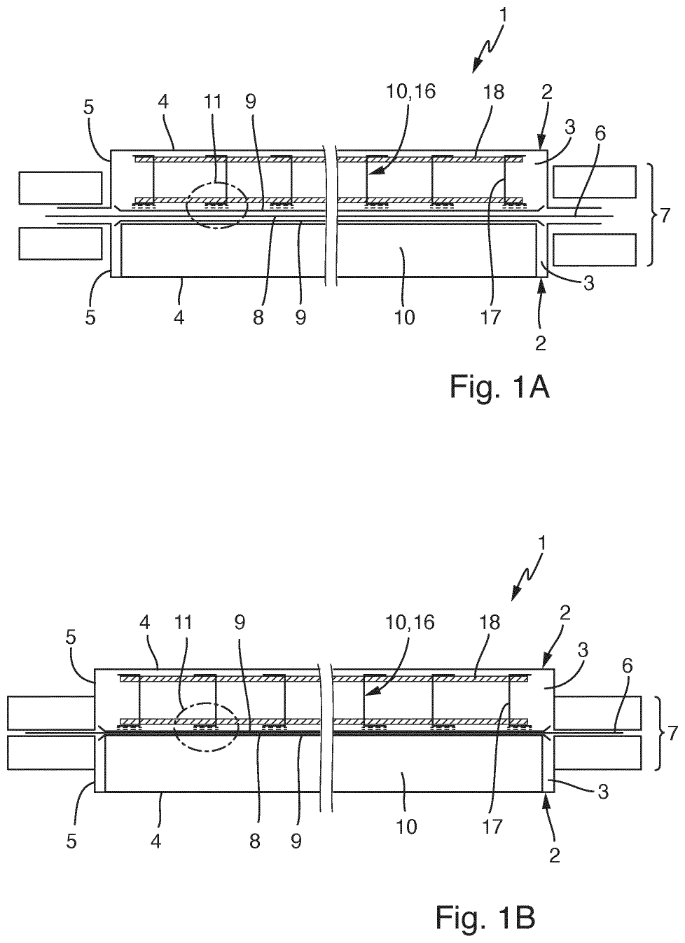

FIGS. 1A and 1B show a first embodiment of the electrolysis cell 1 according to the invention in a cross-sectional view. FIG. 1A shows the cell 1 in an exploded view, e.g. similar to a state during assembly. FIG. 1B shows the assembled cell. The electrolysis cell 1 is suited for chlor-alkali or alkaline water electrolysis. In operation, the cell is turned to a vertical position. The electrolysis cell is connected to electrolyte circuits via feeders and discharge headers (not shown for simplicity).

The electrolysis cell 1 comprises two cell elements 2. The cell elements 2 form the casing of the cell 1. Each of the cell elements 2 defines an electrode chamber 3 by providing a back wall 4 and sidewalls 5 of the electrode chambers 3. A sheet-like separator 6 is interposed in a joint 7 between the two cell elements 2 and provides a separating wall 8 between the electrode chambers 3. The electrode chambers 3 thus form closed half-cells, delimited by the respective cell element 2 and the separator 6.

In each of the electrode chambers 3, there is accommodated an electrode 9 and an electrode support unit 10. One of the electrode chambers 3 forms the anode chamber of the cell 1, which contains the anode as electrode 9, and the other electrode chamber 3 forms the cathode chamber of the cell 1 that contains the cathode as electrode 9. The electrode chambers 3 differ in the chemical environment they have to withstand due to the different electrochemical reactions that take place at the respective electrode. In general, the anode chamber is exposed to the harsher conditions, due to the oxidative effect of the electrolysis products formed in this chamber, i.e. chlorine in case of chlor alkali electrolysis and oxygen in case of alkaline water electrolysis.

The electrode support units 10 provide an electrical connection between the back wall 4 and the electrode 9 in each of the electrode chambers 3. In the assembled state of the cell (cf. FIG. 1B), the electrodes 9 are in direct touching contact with the sheet-like separator 6. According to the invention, in one of the electrode chambers 3, i.e. the upper one in FIG. 1, the electrical connection between the electrode support unit 10 and the electrode 9 is provided by means of a surface contact connection 11. In this example, the electrical connection of the electrode support unit 10 and the back wall 4 is established by a material bond, e.g. by welding.

As can be seen from FIG. 1B, when the joint 7 is closed during assembly of the cell 1, the electrode support unit 10 mounted, preferably welded, on the back wall 4 is pressed against the electrode 9. The electrode 9 is thus sandwiched between the electrode support unit 10 and the separator 6. A surface contact connection 11 is established between the electrode support unit 10 and the electrode 9.

Preferably, the electrode chamber 3, in which the surface contact connection 11 is provided, is an anode chamber of the electrolysis cell 1 comprising an anode as electrode 9.

Preferably, the back wall 4, the electrode support unit 10, and/or the electrode 9 are made from nickel or titanium.

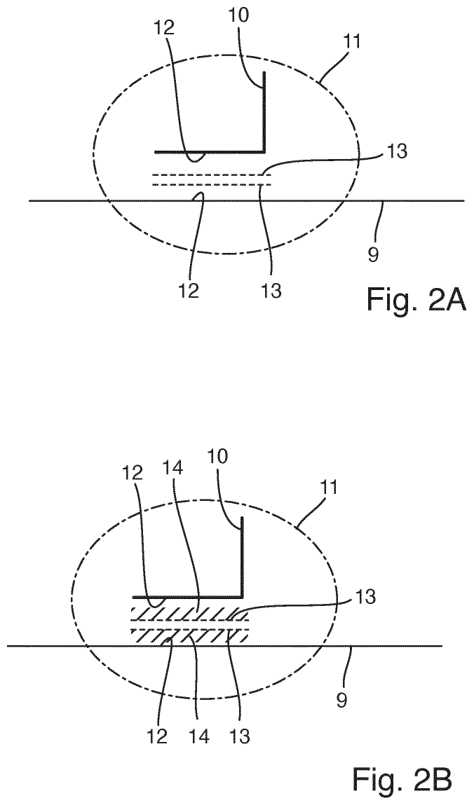

In FIG. 2A the surface contact connection 11 is shown in more detail. The surface contact connection 11 comprises contact surfaces 12 that are equipped with a contact improving coating 13. Thus, the contact improving coatings 13 are provided on both mutually touching contact surfaces 12 of the surface contact connection 11. The contact improving coating 13 is preferably applied to the contact surfaces 12 by electrochemical plating. Other possibilities to apply the coating 13 are e.g. chemical plating or PVD coating. Preferred contact improving coatings 13 contain one or more of the materials gold, silver, platinum, ruthenium, palladium and NiV7. Preferably, contact improving coatings 13 are applied in the anode chamber of the cell 1.

FIG. 2B shows another example of a surface contact connection 11 with a contact improving coating 13. In contrast to FIG. 2A, the contact improving coatings 13 are provided on intermediary coating carrier layers 14 that are attached in a material bond to the electrode support unit 10 and the electrode 9, respectively. Intermediary coating carrier layers 14 are preferably used if an immediate material bonding between the coating 13 and the base material would result in an insufficient adherence of the coating 13 due to the specific material pairing of base material and coating 13. For example, intermediary coating carrier layers 14 made of nickel may serve to promote the adhesion for the aforementioned coating materials.

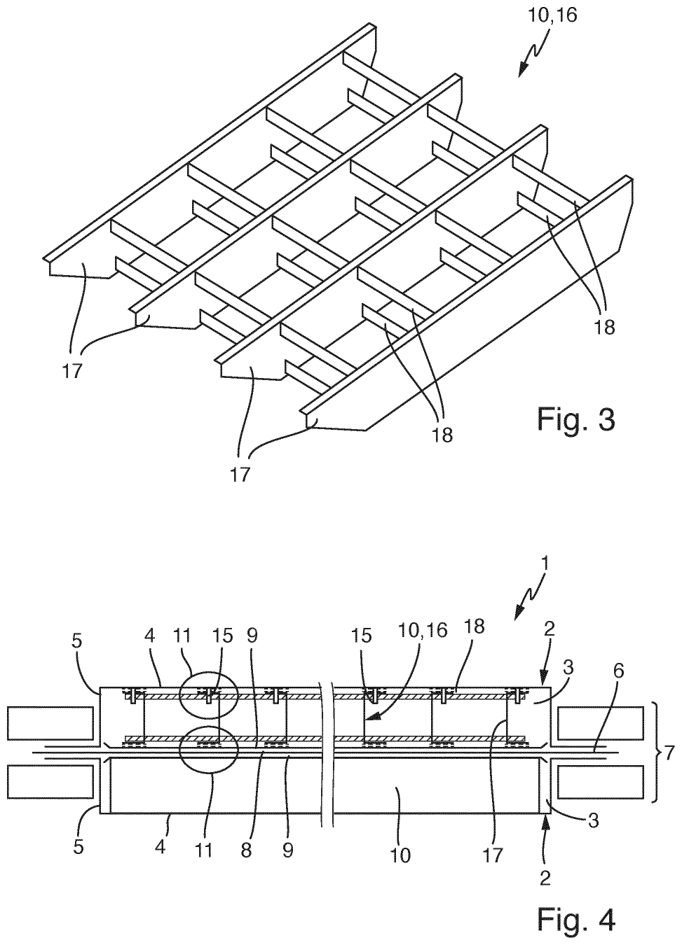

FIG. 3 shows a perspective view of the electrode support unit 10. The electrode support unit 10 comprises a truss 16 made of sheet metal strips 17, 18. A first kind of sheet metal strips 17 form webs that are arranged substantially vertically in an operational state of the cell 1. The webs 17 have bent edges to connect to the back wall 4 and the electrode 9, respectively. The bent edges thus may form the contact surfaces 12 for the surface contact connection 11. The webs 17 are connected to each other by a second kind sheet metal strips 18 as cross bars that stabilize the truss 16. The cross bars 18 are preferably of a rather small cross section in order to avoid significant obstruction of the electrolyte flow within the cell 1.

In FIG. 4, a second embodiment of the electrolysis cell 1 according to the invention is shown. In contrast to the first embodiment, not only the electrical connection between the electrode support unit 10 and the electrode 9, but also between the electrode support unit 10 and the back wall 4 is established by a surface contact connection 11. Thereby the manufacturing effort for the cell 1 is further reduced and welding errors that may lead to leakages of the cell 1 are avoided. Electrode 9 and electrode support unit 10 can simply be removed and replaced.

A further difference to the first embodiment is that the surface contact connection 11 is secured by a mechanical joint 15. The mechanical joint 15 is a separable mechanical joint, preferably a hooked or clamped connection. In the shown example, protruding parts of the electrode support unit 10 are introduced into eyelets fixed to the back wall 4 to secure the surface contact connection 11.

In all other respects, the above description concerning the first embodiment applies to the second embodiment, as well.

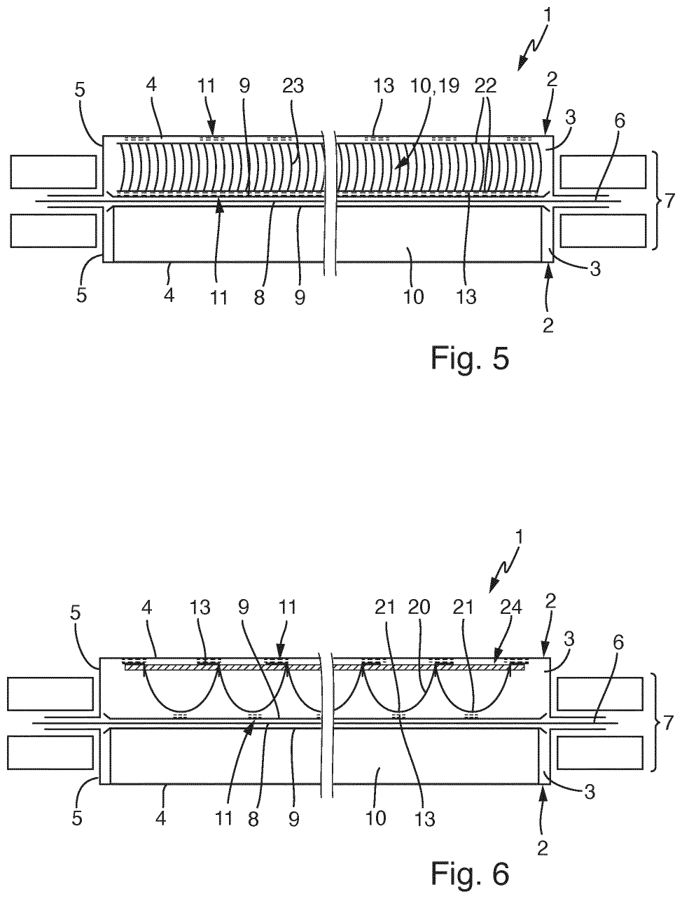

FIG. 5 shows a third embodiment, wherein the electrode support unit 10 comprises an electrically conductive distance fabric 19. The distance fabric 19 has surface layers 22 that are connected by pole threads 23. The pole threads 23 have an inherent rigidity and are compressed during assembly of the cell 1, such that the surface layers 22 are pressed against the back wall 4 and the electrode 9, respectively. The inherent rigidity of the pole threads 23 thus provides for the contact surface pressure of the surface contact connections 11. At least part of the pole threads 23 are made from or are coated with an electrically conductive material. To improve the electrical connection, the surface layer 22 may partly or completely be coated with a contact improving coating 13.

In all other respects, the above description concerning the first and second embodiment applies to the third embodiment, as well.

FIG. 6 shows a fourth embodiment of the inventive electrolysis cell 1. In this embodiment, the electrode support unit 10 comprises arc springs 20 that are convexly arched towards the electrode 9 to provide a resilient support surface 21. The arc springs 20 are mounted on a basic framework 24 that may be formed by a truss of sheet metal strips.

In all other respects, the above description concerning the first to third embodiment applies to the fourth embodiment, as well.

The electrolysis cells 1 shown in the drawings are of the single element type, i.e. both cell elements 2 form a separately sealed single cell. However, the invention is applicable in the same way to electrolysis cells of a filter-press electrolyzer. In this case, the cell elements are the bipolar plates forming the separating wall between adjacent cells.

### LIST OF REFERENCE SIGNS

1 electrolysis cell
2 cell element
3 electrode chamber
4 back wall
5 sidewall
6 separator
7 joint of the cell elements
8 separating wall
9 electrode
10 electrode support unit
11 surface contact connection
12 contact surface
13 contact improving coating
14 coating carrier layer
15 mechanical joint
16 truss
17, 18 sheet metal strips
19 conductive distance fabric
20 arc spring
21 resilient support surface
22 surface layer
23 pole threads
24 basic framework

1-12. (Canceled)

13. An electrolysis cell for chlor-alkali or alkaline water electrolysis, comprising:
two cell elements each defining an electrode chamber by providing a back wall and sidewalls of the electrode chambers; and
a sheet-like separator interposed in a joint between the two cell elements and providing a separating wall between the electrode chambers;
wherein an electrode and an electrode support unit is accommodated in each of the electrode chambers, wherein the electrode support units provide an electrical connection between the back wall and the electrode in each of the electrode chambers, and wherein the electrodes are in direct contact with the sheet-like separator;
wherein at least in one of the electrode chambers the electrical connection between the back wall and the electrode support unit is provided by a surface contact connection;
wherein the electrode support unit includes a truss made of sheet metal strips or the electrode support unit includes arc springs that are convexly arched towards the electrode to provide a resilient support surface.

14. The electrolysis cell according to claim 13, wherein the electrode chamber, in which the surface contact connection is provided, is an anode chamber of the electrolysis cell including an anode as electrode.

15. The electrolysis cell according to claim 13, wherein the surface contact connection includes a contact surface that is equipped at least in part with a contact-improving coating.

16. The electrolysis cell according to claim 15, wherein the contact improving coating contains one or more of the materials gold, silver, platinum, ruthenium, palladium and NiV7.

17. The electrolysis cell according to claim 15, wherein the contact improving coatings are provided on both mutually touching contact surfaces of the surface contact connection.

18. The electrolysis cell according to claim 15, wherein the contact improving coating is provided on an intermediary coating carrier layer that is attached in a material bond to the back wall, the electrode support unit and/or the electrode, respectively.

19. The electrolysis cell according to claim 13, wherein the surface contact connection is secured by a mechanical joint.

20. The electrolysis cell according to claim 19, wherein the mechanical joint is a separable mechanical joint.

21. The electrolysis cell according to claim 19, wherein the mechanical joint is a hooked or clamped connection.

22. The electrolysis cell according to claim 13, wherein the electrode support unit includes an electrically conductive distance fabric.

23. The electrolysis cell according to claim 13, wherein the back wall, the electrode support unit, and/or the electrode are made from nickel or titanium.
